(19) United States
(12) Patent Application Publication
(10) Pub. No.: US 2026/0220801 A1
(43) Pub. Date: Jul. 30, 2026

(54) DEPTH MAP GENERATION FOR 2D PANORAMIC IMAGES

(71) Applicant: Telefonaktiebolaget LM Ericsson (publ), Stockholm (SE)

(72) Inventors: Elijs DIMA, Upplands Väsby (SE); Volodya GRANCHAROV, Solna (SE); Sigurdur SVERRISSON, Kungsängen (SE)

(73) Assignee: Telefonaktiebolaget LM Ericsson (publ), Stockholm (SE)

(21) Appl. No.: 19/151,701

(22) PCT Filed: Jan. 30, 2023
(86) PCT No.: PCT/EP2023/052112

§ 371 Date: Jul. 29, 2025

(51) Int. Cl. G06T 7/50; G06T 7/13; G06T 15/06

(52) U.S. Cl. CPC G06T 7/50; G06T 7/13; G06T 15/06; G06T 2207/10028

(57) ABSTRACT

There is provided techniques for generating a depth map for a 2D panoramic image. A method is performed by an image processing device. The method comprises obtaining a depth map for the 2D panoramic image of a 3D environment. The depth map is generated from a 3D point cloud of the 3D environment. The depth map comprises some pixels with unknown depth values. The method comprises generating an edge map for the depth map. The edge map is generated from the depth map and indicates locations of edges in the 3D point cloud with unknown depth values in the depth map. The method comprises calculating a respective depth value for each of the pixels with unknown depth values in the depth map. Each respective depth value is calculated as a weighted interpolation of known depth values in a region of the depth map that surrounds said respective unknown depth value, where the known depth values do not cross any of the edges in the edge map.

### TECHNICAL FIELD

Embodiments presented herein relate to a method, an image processing device, a computer program, and a computer program product for generating a depth map for a two-dimensional (2D) panoramic image.

### BACKGROUND

In general terms, in the process of three-dimensional (3D) reconstruction, the scene geometry can be represented by a 3D point cloud. In this respect, a 3D point cloud, denoted Ω, can be regarded as an unstructured set of K points in the 3D space (with dimensions X, Y, Z)

$$Ω = {( {X}_{k} , {Y}_{k} , {Z}_{k} )}_{k = 1}^{K}$$

The 3D point cloud can be used to capture the scene geometry and scale, to thereby represent 3D structures from the physical world.

A 3D point cloud can be generated by means of passive (e.g., registering multiple 2D images of the scene and estimating depth values by triangulation) or by active scanning (e.g., light detection and ranging (LIDAR), where the depth values are estimated by measuring the time-of-flight of emitted light).

Since the physical scene to be scanned could be large or have complex geometry, the scanning device is typically placed on a tripod where a scanning is performed. The scanning is then moved to a new location where a new scanning is performed. At each of these positions the scanning device spins around and performs a 360-degree scan of the environment. A scanning performed at one location is therefore referred to as a sweep. A sweep for a given location consists of a 3D point cloud generated from the given scanning location, the parameters for the given scanning location, and a set of 2D images collected at the given scanning location.

The point cloud could be explored by the user directly, using different types of software tools. However, it can be cumbersome for a user to navigate and perform measurements directly in a 3D point cloud. An alternative way of enabling navigation and measurements in a 3D reconstructed scene is to render a 2D panoramic image in a skybox image rendering environment based on the underlying 3D point cloud. In this approach the user is exposed to a panoramic image projected on the side of a cube (and hence the term skybox). In general terms, the source of a skybox can be any form of texture, including photographs, hand-drawn images, or pre-rendered 3D geometry. It is hereinafter assumed that the source of the skybox is a 3D point cloud, and that the 3D point cloud is projected as a panoramic image that is created and aligned in 6 directions, with viewing angles of 90 degrees (which covers the 6 faces of the cube). This can be achieved by cube mapping. In general terms, cube mapping is a technique to create pre-rendered panoramic sky images which are then rendered by a graphical engine as faces of a cube at practically infinite distance with the view point located in the center of the cube. One skybox is formed from a 2D panoramic image 110 obtained from the 3D point cloud of one sweep. In FIG. 1 is illustrated an example skybox image rendering environment composed of one skybox 100 (FIG. 1(a)), where one individual image I_{n,s}={I_{n,-90}, I_{n,0}, I_{n, +90}, I_{n,360}, I_{n,up}, I_{n,down}} of a 2D panoramic image 110 (FIG. 1(b)) is rendered on each side of the skybox 100.

Navigation in the 3D reconstructed scene is then enabled by letting the user move from one cube to another, which corresponds to jump from one sweep to another. Further, measurements are enabled by using a correspondence between the image pixels and the corresponding 3D points in the 3D point cloud. In this way the user can perform measurements in the scene by clicking on pixels, but where the actual dimensions, or distances, are calculated based on the underlying 3D point cloud. That is, the actual measurements are made on the 3D point cloud (i.e., between points in 3D space), for which depth information is required.

One issue with existing techniques for generating depth maps is that the resulting depth map might be sparse and hence incomplete. That is, the depth map might lack depth values at certain pixel locations. In turn, this prevents accurate measurement from being made based on the depth map.

In general terms, there are typically two reasons that might cause uncomplete depth maps. These issues will be discussed next. The first reason is that, usually, the resolution of the 3D point cloud is less than the resolution of the 2D images. Therefore, when the 3D point cloud is projected onto 2D images to create the depth maps, there are gaps of missing data between the depth points. The second reason is that some surfaces and edges in the scanned environment do not correctly reflect the scanner beam back to the scanner. In turn, this might be due to that a beam touching an edge of an object can return two reflections; one from the object, and one from behind the object. This forces the scanner to discard the beam entirely. An example of this is illustrated in FIG. 2. In FIG. 2 is provided a schematic illustration of why most object edges tend to be between measured points for active scanning scenarios. In FIG. 2(a) is illustrated an example setup 210 with an active scanner (cylinder) 215 emitting laser rays (arrows) 225, 230 that either strike an object (cube) 220 or the scene background above/behind the object. In FIG. 2(b) is illustrated an approximate depth map 250 with measured depth values for the example setup 210 in FIG. 2(a). Each laser ray returns a distance, and hence a depth value. Low-magnitude depth values are shown as x: es 265 and high-magnitude depth values are shown as +: es 260. Due to limits on the active scanning resolution, most rays (solid arrows 225 in FIG. 2(a)) do not strike the object's 220 edge, but rather strike below or above it. If a ray does manage to strike the edge (dashed arrow 230 in FIG. 2(a)), then more than one distance is measured along the ray, and the active scanning device 215 discards that measurement, marking an “unknown” or “empty” depth value in the depth map, as indicated by the hollow x 270 in FIG. 2(b). As a result, in the depth map 250, the true position of the object's 220 edges 255 is not on the measured depth points 260, 265, but in the space between them.

The presence of missing depth values does not allow, or enable, the use of the depth map for accurate calculation of the distance between two points in the captured 3D space. Since the 2D color images of the captured scene are assumed to be available, the user can inspect the projection of the captured 3D scene on the 2D image plane, either directly or through an immersive skybox viewer. However, if the user selects a start point and/or end point of the measurement as image pixels that do not have a corresponding depth due to incomplete depth maps, the measuring function will not be able to return any meaningful value.

Techniques exist to fill the incomplete parts of the depth maps (in other words, to bring the resolution of depth maps on par with the resolution of corresponding 2D images of the scene). One approach involves estimating missing depth values as average values of nearby depth values. However, this approach results in inaccuracy around object edges and therefore is not suitable for enabling accurate measurements. Another approach involves utilizing trained neural networks to estimate missing depth values. This, however, requires a good match between test data and training data, as well as enough processing power on the device to execute the operations of the neural network.

Hence, there is still a need for improved generation of depth maps.

### SUMMARY

An object of embodiments herein is to address the above issues.

A particular object is to provide techniques for generation of depth maps that are complete, in the sense that the depth maps do not lack depth values at pixels corresponding to edges.

According to a first aspect these and more objects are addressed by a method for generating a depth map for a 2D panoramic image. The method is performed by an image processing device. The method comprises obtaining a depth map for the 2D panoramic image of a 3D environment. The depth map is generated from a 3D point cloud of the 3D environment. The depth map comprises some pixels with unknown depth values. The method comprises generating an edge map for the depth map. The edge map is generated from the depth map and indicates locations of edges in the 3D point cloud with unknown depth values in the depth map. The method comprises calculating a respective depth value for each of the pixels with unknown depth values in the depth map. Each respective depth value is calculated as a weighted interpolation of known depth values in a region of the depth map that surrounds said respective unknown depth value, where the known depth values do not cross any of the edges in the edge map.

According to a second aspect these and more objects are addressed by an image processing device for generating a depth map for a 2D panoramic image. The image processing device comprises processing circuitry. The processing circuitry is configured to cause the image processing device to obtain a depth map for the 2D panoramic image of a 3D environment. The depth map is generated from a 3D point cloud of the 3D environment. The depth map comprises some pixels with unknown depth values. The processing circuitry is configured to cause the image processing device to generate an edge map for the depth map. The edge map is generated from the depth map and indicates locations of edges in the 3D point cloud with unknown depth values in the depth map. The processing circuitry is configured to cause the image processing device to calculate a respective depth value for each of the pixels with unknown depth values in the depth map. Each respective depth value is calculated as a weighted interpolation of known depth values in a region of the depth map that surrounds said respective unknown depth value, where the known depth values do not cross any of the edges in the edge map.

According to a third aspect these and more objects are addressed by an image processing device for generating a depth map for a 2D panoramic image. The image processing device comprises an obtain module configured to obtain a depth map for the 2D panoramic image of a 3D environment. The depth map is generated from a 3D point cloud of the 3D environment. The depth map comprises some pixels with unknown depth values. The image processing device comprises a generate module configured to generate an edge map for the depth map. The edge map is generated from the depth map and indicates locations of edges in the 3D point cloud with unknown depth values in the depth map. The image processing device comprises a calculate module configured to calculate a respective depth value for each of the pixels with unknown depth values in the depth map. Each respective depth value is calculated as a weighted interpolation of known depth values in a region of the depth map that surrounds said respective unknown depth value, where the known depth values do not cross any of the edges in the edge map.

According to a fourth aspect these and more objects are addressed by a computer program for generating a depth map for a 2D panoramic image. The computer program comprises computer code which, when run on processing circuitry of an image processing device, causes the image processing device to perform actions. One action comprises the image processing device to obtain a depth map for the 2D panoramic image of a 3D environment. The depth map is generated from a 3D point cloud of the 3D environment. The depth map comprises some pixels with unknown depth values. One action comprises the image processing device to generate an edge map for the depth map. The edge map is generated from the depth map and indicates locations of edges in the 3D point cloud with unknown depth values in the depth map. One action comprises the image processing device to calculate a respective depth value for each of the pixels with unknown depth values in the depth map. Each respective depth value is calculated as a weighted interpolation of known depth values in a region of the depth map that surrounds said respective unknown depth value, where the known depth values do not cross any of the edges in the edge map.

According to a fifth aspect these and more objects are addressed by a computer program product comprising a computer program according to the fourth aspect and a computer readable storage medium on which the computer program is stored. The computer readable storage medium could be a non-transitory computer readable storage medium.

Advantageously, these aspects address the above issues when generating depth maps.

Advantageously, these aspects enable depth maps that are complete to be generated, in the sense that the depth maps do not lack depth values at pixels corresponding to edges.

Advantageously, these aspects enable a depth map with missing depth values to be completed, at least with respect to unknown depth values at pixels corresponding to edges being filled in.

Advantageously, these aspects enable accurate measurements to be made in a skybox image rendering environment.

Enabling accurate measurements to be made in a skybox image rendering environment, in turn, leads to a suitability for skybox image rendering environments to be in industrial use-cases, e.g., as digital twins.

These advantages are enabled by accurate localization of edges, and thus accurate filling-in of incomplete depth maps.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates a skybox image rendering environment and a panoramic image according to an example;

FIG. 2 schematically illustrates of why most object edges tend to be between measured points for active scanning scenarios according to an example;

FIG. 3 schematically illustrates a block diagram of an image processing device according to an embodiment;

FIG. 4 is a flowchart of methods according to embodiments;

FIG. 5 schematically illustrates an example edge map according to an embodiment;

FIG. 6 schematically illustrates a search for finding nearest known depth values in a depth map according to an embodiment;

FIG. 7 schematically illustrates a marching ray iteration between the positions of two points according to an embodiment;

FIG. 8 is a schematic diagram showing functional units of an image processing device according to an embodiment;

FIG. 9 is a schematic diagram showing functional modules of an image processing device according to an embodiment; and

FIG. 10 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for improved generation of depth maps

The embodiments disclosed herein therefore relate to techniques for generating a depth map for a 2D panoramic image 110. In order to obtain such techniques there is provided an image processing device, a method performed by the image processing device, a computer program product comprising code, for example in the form of a computer program, that when run on an image processing, causes the image processing device to perform the method.

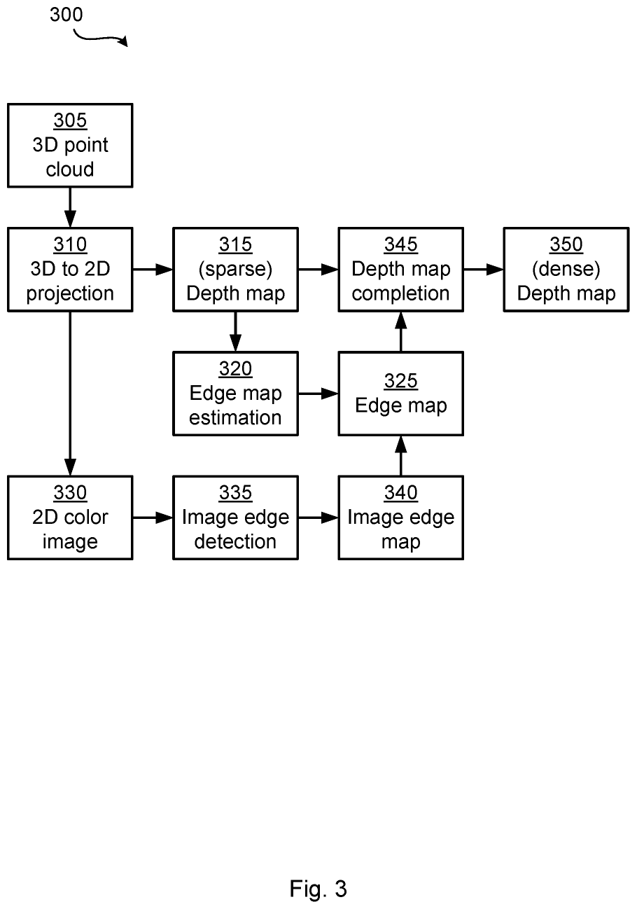

In FIG. 3 is illustrated a block diagram of an image processing device 300 according to an embodiment. A 3D to 2D projection block 310 is configured to generate a (sparse) depth map 315 (and a 2D color image 330) from a 3D point cloud 305. An edge map estimation block 320 is configured to, from the (sparse) depth map 315, generate an edge map 325. Optionally, the edge map estimation block 320 is further configured to generate the edge map 325 from an image edge map 340 as generated from the 2D (color) image 330 by an image edge detection block 335. A depth map completion block 345 is configured to, from the (sparse) depth map 315 and the edge map 325 generate a (dense) depth map 350.

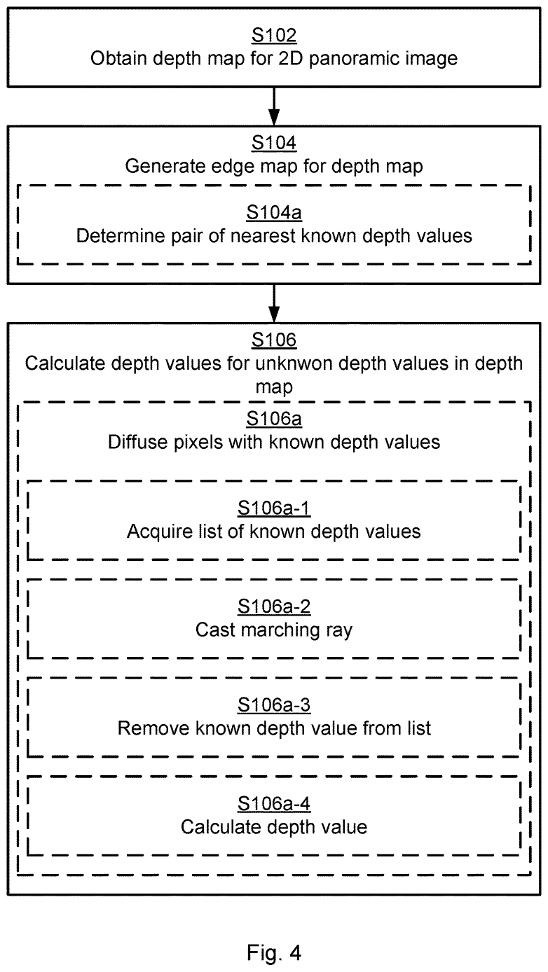

FIG. 4 is a flowchart illustrating embodiments of methods for generating a depth map for a 2D panoramic image 110. The methods are performed by the image processing device 300, 800, 900. The methods are advantageously provided as computer programs 1020.

S102: The image processing device 300, 800, 900 obtains a depth map for the 2D panoramic image 110 of a 3D environment. The depth map is generated from a 3D point cloud of the 3D environment.

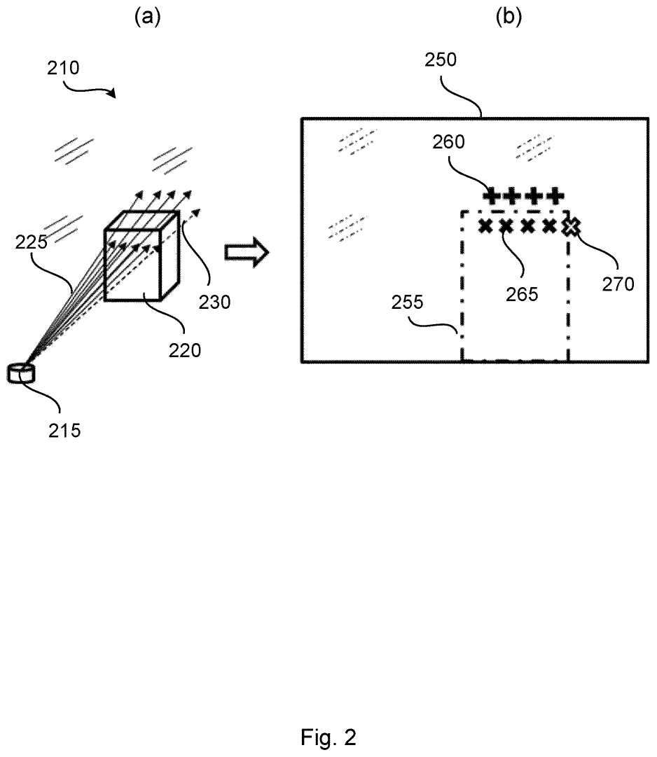

At least some embodiments are based on the understanding that, as explained with reference to FIG. 2, a laser beam hitting an edge of an object will not return a measurement, which in turn will lead to a missing depth value. Therefore, the depth map comprises some pixels with unknown depth values.

Any depth values of edges of objects in the captured scene must be between existing depth values. Therefore, the incomplete regions between the recorded 3D points are checked to find possible edges only at locations (or coordinates) surrounded by 3D points of different depth values (i.e., depth discontinuities). Particularly, the image processing device 300, 800, 900 is configured to perform action S104.

S104: The image processing device 300, 800, 900 generates an edge map 500 for the depth map. The edge map 500 is generated from the depth map and indicates locations of edges in the 3D point cloud with unknown depth values in the depth map.

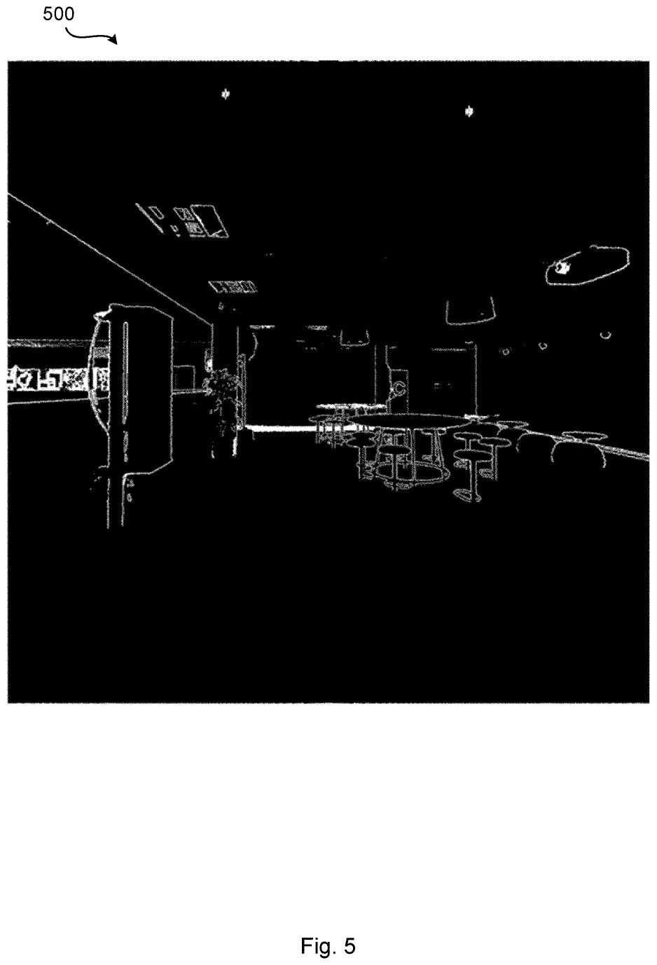

This method thereby finds regions with unknown depth values, where the unknown depth values lie between two sufficiently different, known, depth values. This results in an accurate and complete edge map. Intermediate reference is here made to FIG. 5 which schematically illustrates an example edge map 500 according to an embodiment. In the illustrated edge map 500, locations of edges in the 3D point cloud with unknown depth values in the depth map are illustrated in white.

A respective depth value for each of the pixels with unknown depth values in the depth map can then be calculated as in action S106.

S106: The image processing device 300, 800, 900 calculates a respective depth value for each of the pixels with unknown depth values in the depth map. Each respective depth value is calculated as a weighted interpolation of known depth values in a region of the depth map that surrounds the respective unknown depth value, where the known depth values do not cross any of the edges in the edge map 500.

This method thus enables missing parts of incomplete depth maps to be filled in a precise way that accurately localizes edges between objects in the depth maps. Filled depth maps, especially with depth values around object boundaries (i.e., at edges) allows accurate distance measurements and true sizes of objects (from edge to edge) to be made.

Embodiments relating to further details of generating a depth map for a 2D panoramic image 110 as performed by the image processing device 300, 800, 900 will now be disclosed with continued reference to FIG. 4.

Further aspects of how the depth map for the 2D panoramic image 110 might be obtained will be disclosed next.

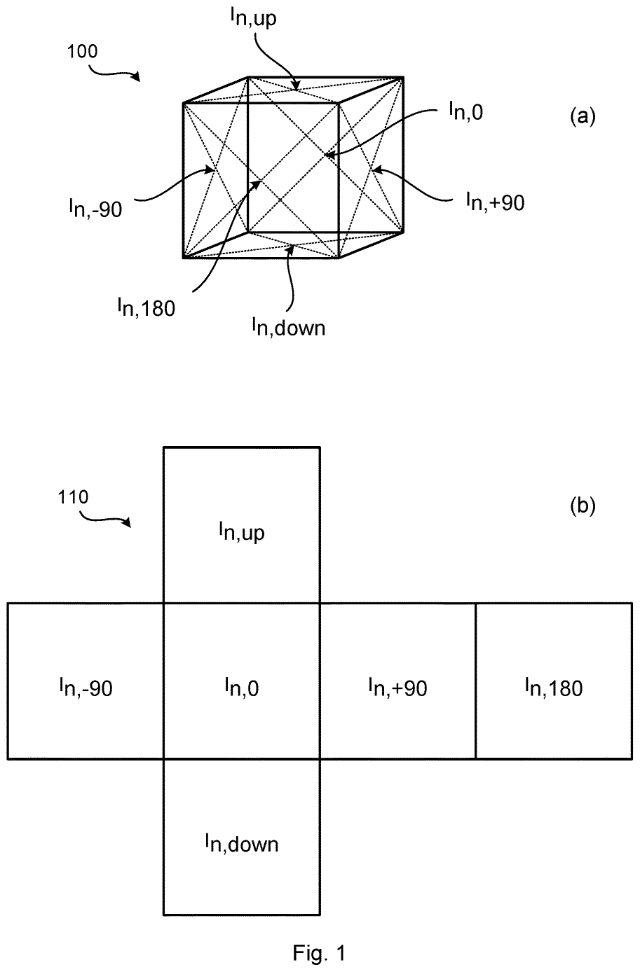

As disclosed above with reference to FIG. 1, in some examples the panoramic image is composed of a set of individual images, with one depth map per individual image.

Particularly, in some embodiments, the 2D panoramic image 110 is to be rendered in a skybox image rendering environment 100, where the panoramic image 110 is composed of a set of individual images I_{n,s}={I_{n,-90}, I_{n,0}, I_{n,+90}, I_{n,360}, I_{n,up}, I_{n,down}}, with one individual image per each side in the skybox image rendering environment 100, and with one depth map per each individual image.

In general terms, the generation of the depth map (one per individual image) might be based on reprojecting the 3D point cloud Ω on each of the images Iₙ, with one depth map per image. This reprojection is performed with the help of sensor pose Pₙ and results in one depth map Dₙ associated with each of the images Iₙ (i.e., with each of the sides of the cube, shown in FIG. 1). Therefore, in some embodiments, the generating in action S104 and the calculating in action S106 are performed for the depth map of each individual image.

The sensor pose P in the 3D point cloud coordinate system can be defined by its position (X_{P}, Y_{P}, Z_{P}) and orientation angles (ω, φ, τ). With the rotation matrix R defined as follows:

$$R = ( \begin{matrix}1 & 0 & 0 \\ 0 & cos ( ω ) & - sin ( ω ) \\ 0 & sin ( ω ) & cos ( ω )\end{matrix} ) ( \begin{matrix}cos ( φ ) & 0 & sin ( φ ) \\ 0 & 1 & 0 \\ - sin ( φ ) & 0 & cos ( φ )\end{matrix} ) ( \begin{matrix}cos ( τ ) & - sin ( τ ) & 0 \\ sin ( τ ) & cos ( τ ) & 0 \\ 0 & 0 & 1\end{matrix} ) ,$$

and the translation vector n defined as follows:

$$n = [ \begin{matrix}{X}_{P} \\ {Y}_{P} \\ {Z}_{P}\end{matrix} ] ,$$

the pose P in homogenous coordinates can be defined as:

$$P = [ \begin{matrix}R & n \\ 0 & 1\end{matrix} ] .$$

Re-projection of a point m=[Xₖ, Yₖ, Zₖ] from the 3D point cloud Ω to the camera coordinate system corresponding to pose P is then given by:

$${m}^{*} = {P}^{T} m .$$

Next,

$${m}^{*} = [ {X}_{k}^{*} , {Y}_{k}^{*} , {Z}_{k}^{*} ]$$

converted into 2D image coordinates (i.e., pixel coordinates) as:

$$[ {u}^{*} , {v}^{*} ] = [ - f \frac{{X}_{x}^{*}}{{X}_{z}^{*}} , - f \frac{{X}_{y}^{*}}{{X}_{z}^{*}} ] + [ {s}_{x} , {s}_{y} ] ,$$

where intrinsic camera parameters, in terms of focal length f and principal point [sₓ, s_{y}], are used.

Then, the depth value d stored at pixel position [u*, v*] is the Euclidian distance between the sensor position n and the point m. That is:

$$d = \sqrt{{( {X}_{P} - {X}_{k} )}^{2} + {( {Y}_{P} - {Y}_{k} )}^{2} + {( {Z}_{P} - {Z}_{k} )}^{2}} .$$

Repeating this for all pixels for a given image results in a depth map associated with the given image on the skybox. Because the 3D points are typically sparser than the 2D color images, the created depth map is sparse, i.e., it contains pixels where no depth value is known, and no 3D point was projected into.

Further aspects of how the edge map might be generated for the depth map will be disclosed next. In general terms, the edge map is generated only for the unknown depth values. In general terms, one edge map is generated per each depth map having unknown depth values. The width and height of the edge map is thus equal to the width and height of the corresponding depth map and image Iₙ.

For each depth map Dₙ, the edge map Mₙ is initialized with “empty” values. In some examples, the “empty” values are represented by the value o.

A search, as will be detailed in the following, is then performed for each “empty” value in the edge map Mn that, in the depth map, does not have a known depth value at the same coordinate. The search is conducted in the depth map for the nearest known depth values. Further, the search is limited to be performed inside K sectors, where K>3 is an even integer. Still further, the search is limited to be performed inside K/2 pairs of opposing sectors; i.e., the pairs (k⁺, k⁻), for k=1, . . . , K/2. In particular, in some embodiments, each pixel with unknown depth value is located at a respective coordinate in the depth map, and the image processing device 300, 800, 900 is configured to perform (optional) action S104a as part of generating the edge map 500 in action S104.

S104a: The image processing device 300, 800, 900 determines, for each pixel with unknown depth value in the depth map, at least one pair of nearest known depth values

$${( {p}_{k}^{+} , {p}_{k}^{-} )}_{k = 1}^{K / 2}$$

to each pixel with unknown depth value in the depth map. Each pair of nearest known depth values is determined by the image processing device 300, 800, 900 searching for the nearest known depth values inside K/2 pairs of opposing sectors at said respective coordinate in the depth map, where K>3 is an even integer, and where pr, pk are known depth values in opposing sectors k⁺ and k⁻.

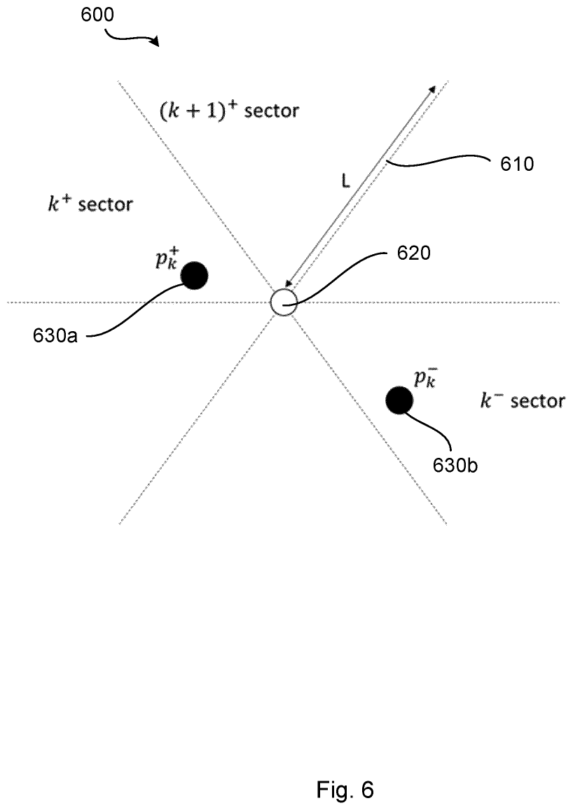

Intermediate reference is here made to FIG. 6. FIG. 6 provides an illustration of the search for finding the nearest known depth values in a depth map 600 with K=6 sectors. Borders between two of the six sectors are indicated at line 610. The hollow circle 620 represents the starting position with an unknown depth value (i.e., an empty pixel in a sparse depth map). The solid circles 630a, 630b represent the nearest known depth values in the depth map for two opposing sectors k⁺ and k⁻. If no known depth value is found in a sector after some distance L, the known depth value in that section is set to the “empty” value. The use of the distance L thus limits the search space. This limiting can be used to improve the search time and handle situations where a large area of depth values in the depth map is missing.

Once the nearest known depth values

$${( {p}_{k}^{+} , {p}_{k}^{-} )}_{k = 1}^{K / 2}$$

are determined for each of the K/2 pairs of opposing sectors, a check is made whether or not the “empty” value in the edge map under consideration corresponds to an edge in the 3D point cloud, and thus corresponds to a (still unknown) depth value that is located between two sufficiently different known depth values in at least one of the considered K/2 pairs of (k⁺, k⁻) opposing sectors, or not.

In some examples, the “empty” value in the edge map under consideration corresponds to an edge in the 3D point cloud if the maximum difference in at least one pair among all the pairs of depth values

$${( {p}_{k}^{+} , {p}_{k}^{-} )}_{k = 1}^{K / 2}$$

is larger than some threshold value. That is, in some examples, the pixel with unknown depth value in the depth map is defined as an edge if:

$${max}_{k} ( \vert {p}_{k}^{+} - {p}_{k}^{-} \vert ) > θ$$

In other words, two known depth values

$${p}_{k}^{+} , {p}_{k}^{-}$$

are defined to be sufficiently different if

$$\vert {p}_{k}^{+} - {p}_{k}^{- 1} \vert > θ$$

for some threshold value θ>0.

If an edge is found, the value at the corresponding coordinate in the edge map Mₙ is set to a “non-empty” value. In some examples the “non-empty” values are represented by value 1.

Each edge map Mₙ is complete when this search has been performed for all “empty” values in the edge map Mₙ.

In some examples, each edge map Mₙ is further refined by being multiplied with an edge map of the corresponding image Iₙ. Therefore, in some embodiments, the edge map 500 further is generated as a function of an edge map of the 2D panoramic image 110.

The edge map of the image Iₙ can be generated by an edge detector, such as a Canny edge detector, a Kovalevsky edge detector, or the like.

Aspects of how the missing depth values might be calculated will be disclosed next.

As disclosed above, the missing (i.e., unknown) depth values in each of the depth map are calculated as weighted interpolation of known depth values in a nearby region that do not cross an edge. Expressed differently, this is equivalent to a diffusion of the known depth values in the depth maps Dₙ, using the edges in the edge map Mₙ as diffusion guides. Hence, in some embodiments, the image processing device 300, 800, 900 is configured to perform (optional) action S106a as part of calculating the depth values in action S106.

S106a: The image processing device 300, 800, 900 diffuses the pixels that in the depth map have known depth values. The edges in the edge map 500 are used as diffusion guides.

In some examples, calculating the respective depth value comprises casting, in the depth map, a marching ray (i.e., performing a ray marching search), along iterated positions, from pixels of known depth values towards the pixel with unknown depth value. Then, when calculating the respective depth value, only known depth values for which the marching ray did not cross any edge with an unknown depth value in the depth map are used in the weighted interpolation of known depth values. In this respect, ray marching can be considered to be a class of image processing methods for 3D computer graphics where rays are traversed iteratively, effectively dividing each ray into smaller ray segments, sampling some function at each step.

In some embodiments, the image processing device 300, 800, 900 is configured to perform (optional) actions S106a-1 to S106a-4 as part of calculating the depth values for each respective pixel with unknown depth value in the depth map in action S106.

S106a-1: The image processing device 300, 800, 900 acquires a respective list of Λ of J known depth values p₁, p₂, . . . , p_{J} for pixels within a window around the pixel with unknown depth value.

That is, for each point p₀ at coordinate [u, v] in the depth map Dₙ with unknown depth value, a list Λ of all nearby points with known depth values within a certain sized window x around [u, v] is assembled (Λ=[p₁, p₂, . . . , pₖ]).

Next, for each of the points with known depth value in Λ, a marching ray is cast from the point with known depth value to p₀ (or from p₀ to the point pₖ with known depth value—the direction does not matter).

S106a-2: The image processing device 300, 800, 900 casts, in the depth map, a marching ray from the pixel of each known depth value pⱼ in the list Λ towards the pixel with unknown depth value.

A marching ray is one way of iterating through all coordinates [x, y] that lie between the positions of pₖ and p₀.

S106a-3: The image processing device 300, 800, 900 removes the known depth value pⱼ from the list Λ if the marching ray crossed an edge with an unknown depth value in the depth map.

S106a-4: The image processing device 300, 800, 900 calculates each respective depth value as a weighted interpolation, as defined by a weight kernel ψ, of all remaining known depth values in the list Λ.

In general terms, when interpolating and calculating the missing depth values in the depth map Dₙ, only those known depths are used, for which ray marching does not encounter an edge in the edge map Mₙ.

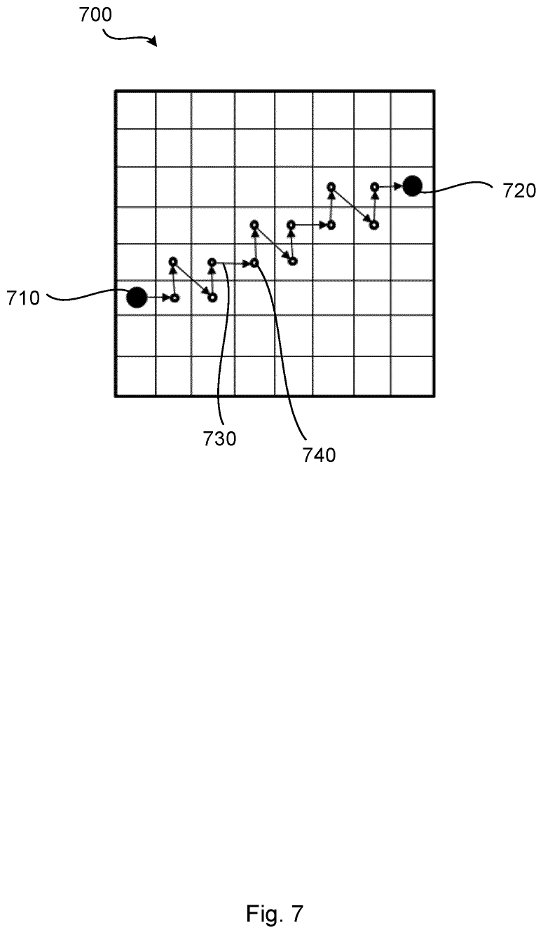

One example of a process to calculate the missing depth values will be disclosed next with reference to FIG. 7. In FIG. 7 is provide an illustration 700 of a marching ray iteration between the positions of two points; a starting point 710 and an endpoint 720. Hollow circles 740 represent all coordinates inspected during the marching ray iteration along the path from point to point as given by arrow 730.

If any of the iterated positions between pₖ and p₀ contain a non-zero label in the edge map M, the depth value pₖ is removed from the list of nearby known depth values Λ.

Once the edge-crossing depth values have been removed from the list Λ, the missing depth p₀ can be calculated as a weighted interpolation of the remaining depth values in Λ with a weights kernel ψ:

$${p}_{0} = {\sum }_{∀ {p}_{i} ∈ Λ} {p}_{i} {ψ}_{i} / {\sum }_{j = 0}^{\vert Λ \vert} {ψ}_{j}$$

In general terms, the weights kernel ψ maps a distance-based weighting term (ψᵢ) for each value (pᵢ) in the list Λ such that greater distances are assigned a lower weight, and vice versa. In some examples, ψᵢ is calculated as the normalized inverse of the Manhattan, or Euclidean, distance between the coordinates of p₀ and pᵢ (given by pos(p₀) and pos(pᵢ), respectively) in the depth map. In some examples, ψᵢ is calculated by a Gaussian kernel of width χ pixels:

$${ψ}_{i} = exp ( - \frac{{‖ pos ( {p}_{0} ) - p o s ( {p}_{i} ) ‖}^{2}}{2 {χ}^{2}} )$$

Hence, in some examples, given the edge, and an interpolation weights kernel, the following process can be performed for each location with a missing depth value in the depth map. Firstly, a weight from the weights kernel is assigned to each known depth value. Secondly, a marching ray search is performed in the edge map from the positions of known depth values to the position of the missing depth values. The marching ray is interrupted if it encounters an edge in the edge map. That is, as noted above, when interpolating and calculating the missing depth values, only those known depth values are used for which the marching ray did not encounter an edge in the edge map.

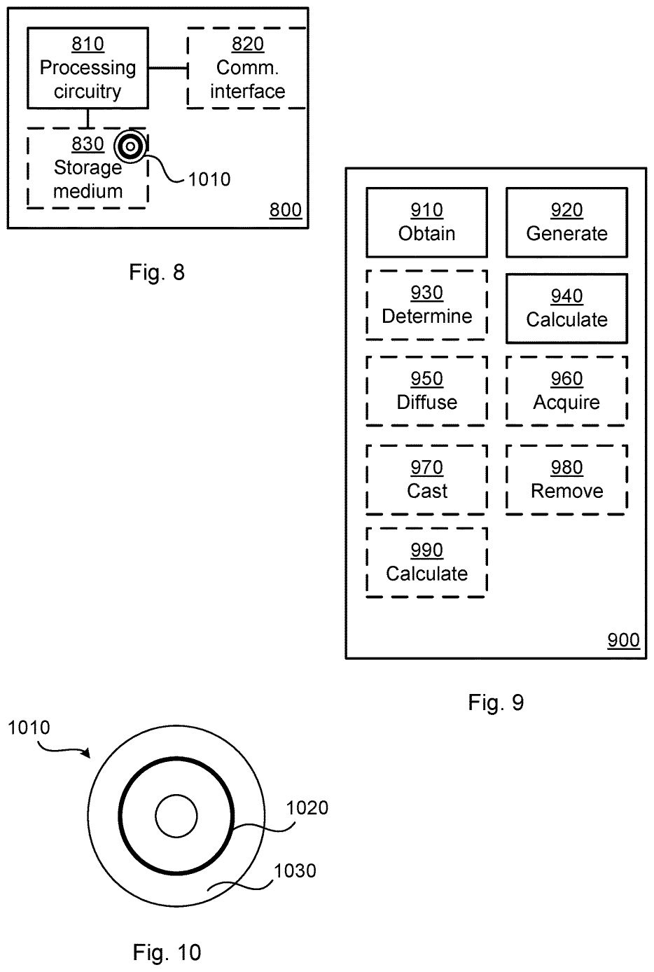

FIG. 8 schematically illustrates, in terms of a number of functional units, the components of an image processing device 300, 800, 900 according to an embodiment. Processing circuitry 810 is provided using any combination of one or more of a suitable central processing unit (CPU), multiprocessor, microcontroller, digital signal processor (DSP), etc., capable of executing software instructions stored in a computer program product 1010 (as in FIG. 10), e.g. in the form of a storage medium 830. The processing circuitry 810 may further be provided as at least one application specific integrated circuit (ASIC), or field programmable gate array (FPGA).

Particularly, the processing circuitry 810 is configured to cause the image processing device 300, 800, 900 to perform a set of operations, or steps, as disclosed above. For example, the storage medium 830 may store the set of operations, and the processing circuitry 810 may be configured to retrieve the set of operations from the storage medium 830 to cause the image processing device 300, 800, 900 to perform the set of operations. The set of operations may be provided as a set of executable instructions.

Thus the processing circuitry 810 is thereby arranged to execute methods as herein disclosed. The storage medium 830 may also comprise persistent storage, which, for example, can be any single one or combination of magnetic memory, optical memory, solid state memory or even remotely mounted memory. The image processing device 300, 800, 900 may further comprise a communications (comm.) interface 820 at least configured for communications with other entities, functions, nodes, and devices. As such the communications interface 820 may comprise one or more transmitters and receivers, comprising analogue and digital components. The processing circuitry 810 controls the general operation of the image processing device 300, 800, 900 e.g. by sending data and control signals to the communications interface 820 and the storage medium 830, by receiving data and reports from the communications interface 820, and by retrieving data and instructions from the storage medium 830. Other components, as well as the related functionality, of the image processing device 300, 800, 900 are omitted in order not to obscure the concepts presented herein.

FIG. 9 schematically illustrates, in terms of a number of functional modules, the components of an image processing device 300, 800, 900 according to an embodiment. The image processing device 300, 800, 900 of FIG. 9 comprises a number of functional modules; an obtain module 910 configured to perform step S102, a generate module 920 configured to perform step S104, and a calculate module 940 configured to perform step S106. The image processing device 300, 800, 900 of FIG. 9 may further comprise a number of optional functional modules, such as any of a determine module 930 configured to perform step S104a, a diffuse module 950 configured to perform step S106a, a acquire module 960 configured to perform step S106a-1, a cast module 970 configured to perform step S106a-2, a remove module 980 configured to perform step S106a-3, and a calculate module 990 configured to perform step S106a-4.

In general terms, each functional module 910:990 may in one embodiment be implemented only in hardware and in another embodiment with the help of software, i.e., the latter embodiment having computer program instructions stored on the storage medium 830 which when run on the processing circuitry makes the image processing device 300, 800, 900 perform the corresponding steps mentioned above in conjunction with FIG. 9. It should also be mentioned that even though the modules correspond to parts of a computer program, they do not need to be separate modules therein, but the way in which they are implemented in software is dependent on the programming language used. Preferably, one or more or all functional modules 910:990 may be implemented by the processing circuitry 810, possibly in cooperation with the communications interface 820 and/or the storage medium 830. The processing circuitry 810 may thus be configured to from the storage medium 830 fetch instructions as provided by a functional module 910:990 and to execute these instructions, thereby performing any steps as disclosed herein.

The image processing device 300, 800, 900 may be provided as a standalone device or as a part of at least one further device. A first portion of the instructions performed by the image processing device 300, 800, 900 may be executed in a first device, and a second portion of the of the instructions performed by the image processing device 300, 800, 900 may be executed in a second device; the herein disclosed embodiments are not limited to any particular number of devices on which the instructions performed by the image processing device 300, 800, 900 may be executed. Hence, the methods according to the herein disclosed embodiments are suitable to be performed by an image processing device 300, 800, 900 residing in a cloud computational environment. Therefore, although a single processing circuitry 810 is illustrated in FIG. 8 the processing circuitry 810 may be distributed among a plurality of devices, or nodes. The same applies to the functional modules 910:990 of FIG. 9 and the computer program 1020 of FIG. 10.

FIG. 10 shows one example of a computer program product 1010 comprising computer readable storage medium 1030. On this computer readable storage medium 1030, a computer program 1020 can be stored, which computer program 1020 can cause the processing circuitry 810 and thereto operatively coupled entities and devices, such as the communications interface 820 and the storage medium 830, to execute methods according to embodiments described herein. The computer program 1020 and/or computer program product 1010 may thus provide means for performing any steps as herein disclosed.

In the example of FIG. 10, the computer program product 1010 is illustrated as an optical disc, such as a CD (compact disc) or a DVD (digital versatile disc) or a Blu-Ray disc. The computer program product 1010 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1020 is here schematically shown as a track on the depicted optical disk, the computer program 1020 can be stored in any way which is suitable for the computer program product 1010.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for generating a depth map for a two-dimensional (2D) panoramic image, the method being performed by an image processing device, the method comprising:
obtaining a depth map for the 2D panoramic image of a three-dimensional (3D) environment, wherein the depth map is generated from a 3D point cloud of the 3D environment, and wherein the depth map comprises some pixels with unknown depth values;
generating an edge map for the depth map, wherein the edge map is generated from the depth map and indicates locations of edges in the 3D point cloud with unknown depth values in the depth map; and
calculating a respective depth value for each of the pixels with unknown depth values in the depth map, wherein the respective depth value is calculated as a weighted interpolation of known depth values in a region of the depth map that surrounds the respective unknown depth value, where the known depth values do not cross any of the edges in the edge map.

2. The method of claim 1, wherein the 2D panoramic image is to be rendered in a skybox image rendering environment, wherein the panoramic image is composed of a set of individual images I_{n,s}={I_{n,-90}, I_{n,0}, I_{n, +90}, I_{n,360}, I_{n,up}, I_{n, down}}, with one individual image per each side in the skybox image rendering environment, and wherein there is one depth map per each individual image.

3. The method of claim 2, wherein the generating and the calculating are performed for the depth map of the each individual image.

4. The method of claim 1, wherein each pixel with unknown depth value is located at a respective coordinate in the depth map, and wherein generating the edge map comprises:
determining, for each pixel with unknown depth value in the depth map, at least one pair of nearest known depth values
$${( {p}_{k}^{+} , {p}_{k}^{-} )}_{k = 1}^{K / 2}$$
to the each pixel with unknown depth value in the depth map by searching for the nearest known depth values inside K/2 pairs of opposing sectors at the respective coordinate in the depth map, where K>3 is an even integer, and wherein
$${p}_{k}^{+} , {p}_{k}^{-}$$
are known depth values m opposing sectors k⁺ and k⁻.

5. The method of claim 4, wherein the pixel with unknown depth value in the depth map is defined as an edge if:
$${max}_{k} ( \vert {p}_{k}^{+} - {p}_{k}^{-} \vert ) > θ$$
where θ>0 is a threshold value.

6. The method of claim 1, wherein the edge map further is generated as a function of an edge map of the 2D panoramic image.

7. The method of claim 1, wherein calculating the respective depth value comprises:
diffusing the pixels that in the depth map have known depth values, wherein the edges in the edge map are used as diffusion guides.

8. The method of claim 1, wherein calculating the respective depth value comprises casting, in the depth map, a marching ray, along iterated positions, from pixels of known depth values towards the pixel with unknown depth value, and wherein, when calculating the respective depth value, only known depth values for which the marching ray did not cross any edge with an unknown depth value in the depth map are used in the weighted interpolation of known depth values.

9. The method of claim 1, wherein calculating the respective depth value for each respective pixel with unknown depth value in the depth map comprises:
acquiring a respective list of A of/known depth values p₁, p₂, . . . , p_{J} for pixels within a window around the pixel with unknown depth value;
casting, in the depth map, a marching ray from the pixel of each known depth value pⱼ in the list Λ towards the pixel with unknown depth value;
removing the known depth value pⱼ from the list Λ if the marching ray crossed an edge with an unknown depth value in the depth map; and
calculating the respective depth value as a weighted interpolation, as defined by a weight kernel ψ, of all remaining known depth values in the list Λ.

10. An image processing device for generating a depth map for a two-dimensional (2D) panoramic image, the image processing device comprising:
memory; and
processing circuitry, the processing circuitry being configured to cause the image processing device to perform a method comprising:
obtaining a depth map for the 2D panoramic image of a three-dimensional (3D) environment, wherein the depth map is generated from a 3D point cloud of the 3D environment, and wherein the depth map comprises some pixels with unknown depth values;
generating an edge map for the depth map, wherein the edge map is generated from the depth map and indicates locations of edges in the 3D point cloud with unknown depth values in the depth map; and
calculating a respective depth value for each of the pixels with unknown depth values in the depth map, wherein the respective depth value is calculated as a weighted interpolation of known depth values in a region of the depth map that surrounds the respective unknown depth value, where the known depth values do not cross any of the edges in the edge map.

11-14. (canceled)

15. The image processing device of claim 10, wherein the 2D panoramic image is to be rendered in a skybox image rendering environment, wherein the panoramic image is composed of a set of individual images I_{n,s}={I_{n,-90}, I_{n,0}, I_{n, +90}, I_{n,360}, I_{n,up}, I_{n,down}}, with one individual image per each side in the skybox image rendering environment, and wherein there is one depth map per each individual image.

16. The image processing device of claim 15, wherein the generating and the calculating are performed for the depth map of the each individual image.

17. The image processing device of claim 10, wherein each pixel with unknown depth value is located at a respective coordinate in the depth map, and wherein generating the edge map comprises:
determining, for each pixel with unknown depth value in the depth map, at least one pair of nearest known depth values
$${( {p}_{k}^{+} , {p}_{k}^{-} )}_{k = 1}^{K / 2}$$
to the each pixel with unknown depth value in the depth map by searching for the nearest known depth values inside K/2 pairs of opposing sectors at the respective coordinate in the depth map, where K>3 is an even integer, and wherein pt, pr are known depth values in opposing sectors k⁺ and k⁻.

18. The image processing device of claim 17, wherein the pixel with unknown depth value in the depth map is defined as an edge if:
$${max}_{k} ( \vert {p}_{k}^{+} - {p}_{k}^{-} \vert ) > θ$$
where θ>0 is a threshold value.

19. The image processing device of claim 10, wherein the edge map further is generated as a function of an edge map of the 2D panoramic image.

20. The image processing device of claim 10, wherein calculating the respective depth value comprises:
Diffusing the pixels that in the depth map have known depth values, wherein the edges in the edge map are used as diffusion guides.

21. The image processing device of claim 10, wherein calculating the respective depth value comprises casting, in the depth map, a marching ray, along iterated positions, from pixels of known depth values towards the pixel with unknown depth value, and wherein, when calculating the respective depth value, only known depth values for which the marching ray did not cross any edge with an unknown depth value in the depth map are used in the weighted interpolation of known depth values.

22. The image processing device of claim 10, wherein calculating the respective depth value for each respective pixel with unknown depth value in the depth map comprises:
acquiring a respective list of Λ of J known depth values p₁, p₂, . . . , p_{J} for pixels within a window around the pixel with unknown depth value;
casting, in the depth map, a marching ray from the pixel of each known depth value pⱼ in the list Λ towards the pixel with unknown depth value;
removing the known depth value pⱼ from the list Λ if the marching ray crossed an edge with an unknown depth value in the depth map; and
calculating the respective depth value as a weighted interpolation, as defined by a weight kernel ψ, of all remaining known depth values in the list Λ.

23. A non-transitory computer readable storage medium storing a computer program for generating a depth map for a two-dimensional (2D) panoramic image, the computer program comprising computer code which, when run on processing circuitry of an image processing device, causes the image processing device to perform a method comprising:
obtaining a depth map for the 2D panoramic image of a three-dimensional (3D) environment, wherein the depth map is generated from a 3D point cloud of the 3D environment, and wherein the depth map comprises some pixels with unknown depth values;
generating an edge map for the depth map, wherein the edge map is generated from the depth map and indicates locations of edges in the 3D point cloud with unknown depth values in the depth map; and
calculating a respective depth value for each of the pixels with unknown depth values in the depth map, wherein the respective depth value is calculated as a weighted interpolation of known depth values in a region of the depth map that surrounds the respective unknown depth value, where the known depth values do not cross any of the edges in the edge map.
